(19) United States
(12) Patent Application Publication
(10) Pub. No.: US 2001/0036018 A1
(43) Pub. Date: Nov. 1, 2001

(54) Optical element

(75) Inventor: Norikazu Arai, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA CORPORATION

(21) Appl. No.: 09/840,113

(22) Filed: Apr. 24, 2001

(30) Foreign Application Priority Data
Apr. 26, 2000 (JP) 126061/2000

(51) Int. Cl. G11B 7/135; G11B 7/00

(52) U.S. Cl. 359/642; 359/566; 369/112.08

(57) ABSTRACT

An optical element, comprises an optical surface provided with a stepped level difference, wherein when the stepped level difference is viewed from a direction of an optical axis, the stepped level difference is provided in a form of a single continuous line in which a starting point of the line does not agree with an ending point of the line.

### BACKGROUND OF THE INVENTION

The present invention relates to optical elements, especially, those optical elements intended for an optical pickup apparatus that can be manufactured easily and at relatively low costs.

Optical elements whose optical surfaces vary in shape and pattern according to requirements are already proposed. In recent years, in particular, optical systems for convergence in an optical pickup apparatus intended for high-density optical information recording on or reproduction from recording media, optical systems for scanning in a laser beam printer, optical systems for connecting a semiconductor laser and fibers in optical communications equipment, and optical systems for a bar code reader, have been proposed for use in optical equipment having a laser such as a semiconductor laser. Under these circumstances, processes for controlling the wavelength dependence of such optical systems by providing their optical elements with diffraction patterns in order to solve the problems that arise from the fact that fluctuations in the wavelengths of semiconductor lasers are caused by mode hopping, changes in light emission output, and changes in environmental temperature, are being proposed. Lenses provided with diffraction patterns to control the axial chromatic aberration of the lenses are proposed as one such example. For the glass lenses produced by polishing (lapping), it is difficult to provide these diffraction patterns. For plastic lenses, however, diffraction patterns can be formed stably and accurately on optical surfaces by injecting resin into dies.

It is known that when diffraction patterns are provided on the surfaces of optical elements such as parallel flat plates, photolithography or electron-ray direct patterning is used to manufacture metallic dies for molding these optical elements, and any diffraction pattern of the order of sub-microns can be accurately formed using these manufacturing processes. However, the manufacturing processes, although suitable for printing diffraction patterns on the faces of dies, are usually unsuitable for printing diffraction patterns on the spherical or non-spherical surfaces of dies.

It is therefore known that when diffraction patterns are provided on the spherical or non-spherical surfaces of lenses and the like, diffraction patterns consisting of multiple ring zones of rotation symmetry are printed on the spherical or non-spherical surfaces of dies by using a cutting process with an ultra-precision CNC lathe (biaxial lathe) and a diamond cutting tool. However, since ring zones have their leading and trailing ends shaped into loop form, the processes of moving the diamond cutting tool away from the die, moving adjacent zones to their required forming positions, and bringing the tool into contact with the next zone for cutting must be repeated each time a ring zone is cut. For this reason, tool damage and wear frequently occur and highly accurate diffraction patterns are difficult to obtain. To form diffraction patterns for larger-aperture lenses or increase the number of zones in a diffraction pattern, in particular, the above processes must be repeated even more often, and this causes significant tool damage and wear.

Furthermore, taking as an example the converging optical systems of the optical pickup apparatus used for high-density optical record information recording on or reproduction from a recording medium, one can see that in general, these optical systems in recent years are classified into a scheme under which light is converged by combining an objective lens and a set of coupling lenses for converting the degree of divergent of the light fluxes emitted from the semiconductor laser provided inside (these coupling lenses include a collimating lens by which the degree of divergent of the emitted light fluxes from the semiconductor laser are converted into parallel light fluxes), and a scheme under which coupling lenses for converting the degree of divergent of the light fluxes emitted from the semiconductor laser are not provided and the emitted light fluxes from the semiconductor laser are converged using only an objective lens. The movement of focus due to changes in the wavelength of the semiconductor laser, and the deterioration of wave aberration can be suppressed by providing diffraction patterns so as to correct the axial chromatic aberration and spherical chromatic aberration (namely, the wavelength dependence of spherical aberration) of the converging optical system.

A digital versatile disc (DVD) of the same size as that of the compact disc (CD), the conventional optical information recording medium, and higher than CD in terms of recording density has been developed in recent years and is rapidly proliferating. A laser usually ranging from 635 to 660 nm in the wavelength of its light source is used to play DVD, in which process, the emitted light fluxes are converted into parallel light fluxes by a collimating lens and then the parallel light fluxes, after being passed through an objective lens whose number of apertures (NA) at the optical information recording medium side is 0.6, are converged on an information recording plane via the transparent substrate off the information recording medium. The recording capacity of CD is 640 megabytes (MB), whereas that of DVD is 7 gigabytes (GB).

Recently, optical information recording media of the same size as that of CD or DVD and ranging from 10 to 30 GB in recording capacity are actively developed using objective lenses even higher in NA and light sources even shorter in wavelength. A GaN blue semiconductor laser and an SHG blue laser are now receiving attention as promising shorter-wavelength light sources for an optical pickup apparatus intended to record information on or reproduce information from such optical information recording media. Although the GaN blue semiconductor laser neither generates too much noise nor fluctuates in wavelength, the SHG blue laser (usually about 400 nm in oscillation wavelength) has the disadvantages that as with the current semiconductor lasers, it has temperature-dependence in terms of oscillation wavelength and suffers wavelength fluctuations associated with mode hopping and laser output, that high-frequency superimposition is required for the reduction of laser noise, and that the monochromatism at the oscillation wavelength is inferior. Therefore, in the case of a converging optical system for a pickup apparatus intended for a high-density optical information recording medium which uses the GaN blue semiconductor laser, the necessity for correcting axial chromatic aberration is increasing.

By the way, for lenses, prisms (or mirrors), and other various optical elements, refractive index “n” is represented as the function of wavelength “λ”, irrespective of whether the element is made of a plastic material or a glass material. If this relationship is taken as “n(λ)”, although a change in relative refractive index with respect to a change in unit wavelength (i.e., “dn/dλ”) is also the function of “λ”, when a comparison is made between the case that the wavelength “λ” of the laser light source is 650 nm and the case that the “λ” value is 400 nm, the case of 400 nm is four to five times as great as that of 650 nm in terms of the change in refractive index with respect to the change in unit wavelength, even if the optical elements in both cases are made of the same material. To correct axial chromatic aberration to the same extent as that of the case of 650 nm, therefore, the need arises also to increase the number of ring zones in the diffraction pattern by four to five times. This, in turn, makes it necessary to use a sharper-tipped cutting tool when a metallic die for molding optical elements is to be manufactured to minimize reduction in diffraction efficiency, associated with the increase in the number of ring zones.

### SUMMARY OF THE INVENTION

An object of the present invention allowing for the above factors is to obtain a larger-aperture optical element having a stepped complex surface shape which develops a diffraction effect, and an optical element that enables not only the improvement of the diffraction effect, but also the improvement of die machining accuracy with minimum tool damage.

Another object of the present invention is to obtain a lower-cost and higher-accuracy optical element having a stepped complex surface shape which develops a diffraction effect on the curved surface required to the highly accurate for use in an optical pickup apparatus intended for recording on or reproduction from a high-density optical information recording medium which uses a blue semiconductor laser.

According to the present invention, the above object can be achieved by the following structures.

(1) An optical element, comprises an optical surface provided with a stepped level difference, wherein when the stepped level difference is viewed from a direction of an optical axis, the stepped level difference is provided in a form of a single continuous line in which a starting point of the line does not agree with an ending point of the line.

(2) In the optical element of (1), when the stepped level difference is viewed from a direction of an optical axis, the stepped level difference is continued from the starting point to the ending point over 360 degrees.

(3) In the optical element of (1), when the stepped level difference is viewed from a direction of an optical axis, the stepped level difference is shaped in a spiral.

(4) In the optical element of (1), when the stepped level difference is viewed from a direction of an optical axis, the single continuous line is made such that in a plurality of coaxial ring-shaped bands, adjacent ring-shaped bands are linked at a part thereof.

(5) In the optical element of (1), the optical element is made of a resin.

(6) In the optical element of (1), the optical element is a optical element for use in an optical pickup apparatus.

(7) In the optical element of (1), the optical element is a lens.

(8) In the optical element of (7), the optical element is an objective lens for use in an optical pickup apparatus.

(9) In the optical element of (7), the optical element is a coupling lens for use in an optical pickup apparatus.

(10) In the optical element of (1), the optical surface is a diffracting surface having a diffracting function.

(11) In the optical element of (10), the diffracting surface is a diffracting surface having an achromatic function.

(12) In the optical element of (10), the optical element is an optical element for use in an optical pickup apparatus conducting recording and/or reproducing information of an optical information recording medium, and wherein in case that a first light flux having a first light wavelength for reproducing or recording information from or onto a first optical information recording medium passes through the diffractive surface to generate at least one diffracted ray, the intensity of an n-th order diffracted ray of the first light flux is greater than that of any other order diffracted ray of the first light flux, and in case that a second light flux having a second light wavelength for reproducing or recording information from or onto a second optical information recording medium passes through the diffractive surface to generate at least one diffracted ray, the intensity of an n-th order diffracted ray of the second light flux is greater than that of any other order diffracted ray of the second light flux, where n stands for an integer other than zero, the first wavelength is different from the second wavelength.

(13) An optical pickup apparatus for conducting recording or reproducing information of an optical information recording medium, comprises:

a light source to emit light flux used for recording or reproducing information of the optical information recording medium;

an optical converging system to converge the light flux emitted from the light source onto an information recording plane of the optical information recording medium, and the optical converging system having an optical element; and

a photo-detector to receive the light flux reflected from the information recording plane of the optical information recording medium and to detect the light flux;

wherein the optical element, comprising:

an optical surface provided with a stepped level difference, wherein when the stepped level difference is viewed from a direction of an optical axis, the stepped level difference is provided in a form of a single continuous line in which a starting point of the line does not agree with an ending point of the line.

(14) An optical information recording and/or reproducing apparatus for conducting recording or reproducing information of an optical information recording medium, comprises:

an optical pickup apparatus, comprising:

a light source to emit light flux used for recording or reproducing information of the optical information recording medium;

an optical converging system to converge the light flux emitted from the light source onto an information recording plane of the optical information recording medium, and the optical converging system having an optical element; and

a photo-detector to receive the light flux reflected from the information recording plane of the optical information recording medium and to detect the light flux;

wherein the optical element, comprising:

an optical surface provided with a stepped level difference, wherein when the stepped level difference is viewed from a direction of an optical axis, the stepped level difference is provided in a form of a single continuous line in which a starting point of the line does not agree with an ending point of the line.

Further, the foregoing objects may be achieved the following preferable structures.

An optical element is intended for an optical pickup apparatus, and are characterized in that it is placed in the optical pickup apparatus and in that the stepped region when viewed from the direction of the optical axis includes an optical surface of a single-cut form (a single continuous line) in which the starting point and ending point of the optical surface do not agree.

To provide the above-mentioned optical element with stepped portions on each optical surface by using a die, the dents corresponding to the particular differences in surface level must be formed on the corresponding face of the die. Under the prior art, since the dents required are a plurality of circumferential grooves formed concentrically according to the particular difference in surface level, to form these dents, it is necessary that the processes of bringing the tip of a cutting tool into contact with the die and moving the tool tip away therefrom should be repeated as often as there actually are circumferential grooves. According to the present invention, however, since continuous grooves can be formed by moving the tool tip to relative positions with respect to the die in single-cutting form without moving the tool tip away therefrom once it has been brought into contact, tool wear can be suppressed and the die manufacturing time can be reduced. In addition, optical element provided with a continuously stepped optical surface which produces the desired diffraction effect can be manufactured using the die that has thus been formed. Furthermore, achromatization and spherical aberration correction, for example, can be achieved with a smaller number of optical element by developing the diffraction effect appropriately by use of the stepped regions created on the optical surfaces of said optical element. In this sense, said optical element is suitable for an optical pickup apparatus whose design is to be made more compact.

The usable types of optical element having a stepped spherical or non-spherical surface include an objective lens by which, when information is recorded on or reproduced from different types of optical information recording media such as DVD and CD, recorded information/reproduced information can be converted into common optical images, a set of coupling lenses (collimating lens included) that alleviates the deterioration of a plastic objective lens in terms of spherical aberration due to changes in environmental temperature, an objective lens whose deterioration in spherical aberration due to changes in environmental temperature is self-alleviated according to the particular diffraction effect, an objective lens that has been increased in the number of apertures by enhancing diffraction power, and so on. Also, such optical element can be used in the scanning optical system of a laser beam printer, an optical system for connecting a semiconductor laser and fibers in optical communications equipment, and a bar code reader optical system applying a semiconductor laser. Although various methods are proposed that enable the surfaces of photographic lenses, finders, and other visible-light-used optics to be provided with a stepped region for developing a diffraction effect on a curved surface, these optical element, compared with diffraction optical element intended for a semiconductor laser, are large in terms of optical surface effective area and may deteriorate die machinability. These disadvantages, however, can also be improved by applying the present invention.

It is preferable that the single-cut form of said optical element for an optical pickup apparatus should be spiral when viewed from the direction of the optical axis. Thus, said optical element can be manufactured easily and at low costs and wear on the diamond cutting tool can be further reduced.

In said optical element for an optical pickup apparatus, the angle of rotation from the starting point of the stepped region to the ending point should preferably be greater than 360 degrees. Thus, the number of times the diamond cutting tool is to be brought into contact with the die and moved away therefrom can be minimized and tool wear can be reduced.

The above-mentioned possibilities can be embodied by using those optical element intended for an optical pickup apparatus that is characterized in that it is placed in the optical pickup apparatus and in that a stepped region having a surface extended almost parallel with respect to the optical axis is formed on each optical surface, and in that said stepped region is continuous in excess of 360 degrees around the optical axis.

It is preferable that said optical element for an optical pickup apparatus should be placed in the optical pickup apparatus and that they should have their stepped regions formed into a spiral shape when viewed from the direction of the optical axis. Thus, said optical element can be manufactured easily and at low costs and wear on the diamond cutting tool can be further reduced.

In said optical element for an optical pickup apparatus, said optical surface should preferably be a diffractive surface on which a diffraction function is bestowed by the stepped region. Thus, optical element with a diffractive surface can be obtained less expensively and in greater quantities, with the result that an optical pickup apparatus can be obtained at a lower cost.

Said optical element for an optical pickup apparatus should preferably be objective lenses or coupling lenses. Thus, lenses having a variety of functions can be obtained at lower costs.

In said optical element for an optical pickup apparatus, said optical surface should preferably be a diffractive surface on which an achromatizing function is bestowed by the stepped region. Thus, optical element having a diffractive surface provided with an achromatizing function can be obtained less expensively and in greater quantities.

In said optical element for an optical pickup apparatus, the stepped region should preferably be formed on almost the entire optical surface.

In said optical element for an optical pickup apparatus, the number of turns in the stepped region should preferably be 10 or more, but up to 2,000. If the number of turns in the stepped region is 10 or more, the diffraction effect can be developed more efficiently, and if the number of turns is up to 2,000, the appropriate interval between the stepped portions can be reserved. As a result, the manufacture of said optical element can be simplified in both cases.

The possibilities mentioned above can be embodied by using optical element characterized in that the stepped region when viewed from the direction of the optical axis includes a optical surface of a single-cut form in which the starting point and ending point of the optical surface do not agree.

To form said optical element using a die, the face corresponding to said optical surface of each optical element must be cut into a shape suitable for complementing the stepped region. To form a stepped region on the optical surface of the optical element, therefore, the dents corresponding to the stepped region must be formed. Under the prior art, since the dents required are a plurality of circumferential grooves formed concentrically according to the particular difference in surface level, to form these dents, it is necessary that the processes of bringing the tip of a cutting tool into contact with the die and moving the tool tip away therefrom should be repeated as often as there actually are circumferential grooves. According to the present invention, however, since continuous grooves can be formed by moving the tool tip to relative positions with respect to the die in single-cutting form without moving the tool tip away therefrom once it has been brought into contact, tool wear can be suppressed and the die manufacturing time can be reduced. In addition, optical element provided with a continuously stepped optical surface which produces the desired diffraction effect can be manufactured using the die that has thus been formed.

It is preferable that the single-cut form of said optical element should be spiral when viewed from the direction of the optical axis. Thus, said optical element can be manufactured easily and at low costs and wear on the diamond cutting tool can be further reduced.

In said optical element, the angle of rotation from the starting point of the stepped region to the ending point should preferably be greater than 360 degrees. Thus, the number of times the diamond cutting tool is to be brought into contact with the die and moved away therefrom can be minimized and tool wear can be reduced.

The above-mentioned possibilities can be embodied by using optical element characterized in that a stepped region having a surface extended almost parallel with respect to the optical axis is formed on each optical surface and in that said stepped region is continuous in excess of 360 degrees around the optical axis, wherein “continuous” includes not only a status in which faces are connected on a smooth curved surface, but also a status in which faces are connected in corner provided form.

It is preferable that said optical element should have their stepped regions formed into a spiral shape when viewed from the direction of the optical axis. Thus, said optical element can be manufactured easily and at low costs and wear on the diamond cutting tool can be further reduced.

In said optical element, said optical surface should preferably be a diffractive surface on which a diffraction function is bestowed by the stepped region. Thus, optical element with a diffractive surface can be obtained less expensively and in greater quantities.

In said optical element, said optical surface should preferably be a diffractive surface on which an achromatizing function is bestowed by the stepped region. Thus, optical element having a diffractive surface provided with an achromatizing function can be obtained less expensively and in greater quantities.

In said optical element, the stepped region should preferably be formed on almost the entire optical surface.

In said optical element, the number of turns in the stepped region should preferably be 10 or more, but up to 2,000. If the number of turns in the stepped region is 10 or more, the diffraction effect can be developed more efficiently, and if the number of turns is up to 2,000, the appropriate interval between the stepped portions can be reserved. As a result, the manufacture of said optical element can be simplified in both cases.

The term “surface level differences” used in this SPECIFICATION means not only the surface level differences that use diffraction to deflect light fluxes, but also surface level differences more significant than those which generate essential changes in the length of the optical axis. Preferably, portions with surface level differences, or stepped portions, should be provided for forming a diffraction portion, and more preferably, these stepped portions should have a face extended almost parallel with respect to the optical axis. Under the present invention, stepped portions are continuously formed in single-cut form. These stepped portions can take, for example, either a spiral shape or a shape in which some of coaxially formed ring zones different in diameter are partly connected to each other in a radial direction.

Since the term “achromatization” in this SPECIFICATION refers to a technique well known to the interest concerned, detailed description of this technique is omitted. The achromatizing function can be, for example, a function that reduces the axial chromatic aberration and/or spherical aberration components of other optical element or of the entire optical system, or a function that reduces these chromatic aberration components of the particular optical element itself.

The “objective lens” in this SPECIFICATION refers loosely to a converging lens provided as close as possible to and facing an optical information recording medium which has been loaded into an optical pickup apparatus, and strictly to the above-mentioned lens and a group of lenses which can be operated by an actuator at least in its axial direction, wherein the group of lenses refers to at least one or more lenses.

The “optical information recording medium” in this SPECIFICATION includes: a compact disk such as CD-R, CD-RW, CD-Video, or CD-ROM; a digital versatile disk such as a DVD-ROM, DVD-RAM, DVD-R, DVD-RW, or DVD-Video; the current type of disk-shaped optical information recording medium, such as a mini-disk (MD); or a recording medium of the next generation.

The term “information recording and reproduction” in this SPECIFICATION means recording information on the information recording plane of any such type of information recording medium as mentioned above, and reproducing information that has been recorded on the information recording plane. The optical pickup apparatus pertaining to the present invention can be one that is to be used for only either recording or reproduction, or can be one that is to be used for both recording and reproduction. Or the optical pickup apparatus can be one intended for recording on an information recording medium and for reproduction from another information recording medium, or can be an apparatus intended for either recording on or reproduction from an information recording medium and for both recording on and reproduction from another information recording medium. Also, the term “reproduction” here includes a function that simply reads information.

The optical pickup apparatus pertaining to the present invention can be mounted in various types of players, drives, or the like, or in the audio and/or video recording and/or playing units of the AV equipment, personal computers, or other information terminals containing the above products.

### BRIEF DESCRIPTION OF THE DRAWINGS

FIG. 1 is a schematic block diagram of the optical pickup apparatus pertaining to an embodiment of the present invention.

FIG. 2 is a diagonal view of an objective lens used in the present invention.

FIGS. 3(a) and 3(b) are views of the objective lens when seen from the direction of its optical axis.

### DETAILED DESCRIPTION OF THE PREFERRED EMBODIMENT

Each optical element under the present invention has an optical surface provided with surface level differences, and these surface level differences are provided in single-cut form (single continuous line) in which the starting point and ending point of the optical surface do not agree when the surface level differences are viewed from the direction of the optical axis.

It is also preferable that the surface level differences, when viewed from the direction of the optical axis, are continuous in excess of 360 degrees around the optical axis.

For example, as shown in FIG. 3(a), the surface level differences should preferably be spiral when viewed from the direction of the optical axis, or as shown in FIG. 3(b), the surface level differences, when viewed from the direction of the optical axis, should preferably have a single-cut form in which, in a region consisting of a plurality of concentric ring zones, some of adjacent ring zones are connected to each other. It is also preferable that for these shapes of the surface level differences, the number of turns should be 10 or more, but up to 2,000. Further, in the shape shown in FIG. 3(b), a single ring may be formed on the same plane. However, it may also possible to form a single ring such that the height of the ring in the optical direction is different depending on a position of the single lens.

Although the optical elements under the present invention can be either of resin make or glass make, the invention can produce more significant effects with resin make.

Also, although the optical elements under the present invention can be used in various applications such as scanning with the internal optical system of a laser beam printer, optical communications using an optical system intended to connect a semiconductor laser and fibers, and bar code reading with an optical system, said optical elements should preferably be used for an optical pickup apparatus intended for information recording on and reproduction from an optical information recording medium.

In addition, the optical elements under the present invention should preferably be lenses since the present invention produce more significant effects, and the optical elements, if intended for the optical pickup apparatus mentioned above, can be applied to objective lenses, coupling lenses, or the like.

Furthermore, the optical surface can be a diffractive surface having a diffraction function, and the diffractive surface can be one having an achromatizing function.

Surface level differences can be provided on only one portion of the optical surface or can be provided on almost the entire optical surface. Although “Surface level differences can be provided on almost the entire optical surface” means that the area occupied by the stepped region of the entire optical surface (the face between adjacent stepped portions is, of course, included in this stepped region) should be, preferably, at least 80% of the area of the optical surface, or more preferably, at least 90% thereof.

Also, when the optical surfaces of the optical elements under the present invention is a diffractive surface and these optical elements are used for the optical pickup apparatus pertaining to the invention, the configuration of this optical pickup apparatus is described below. The optical pickup apparatus for reproducing information from, or recording information on, an optical information recording medium comprises: a light source that emits the light fluxes to be used for reproducing information from, or recording information on, the optical information recording medium; optical elements contained in a converging optical system by which the light fluxes that have been emitted by the light source are converged on the information recording plane of the optical information recording medium; and a photo-detector that receives and detects the light fluxes reflected from the information recording plane of the optical information recording medium.

In this configuration, the optical elements within the converging optical system are the optical elements under the present invention.

Also, it is preferable that the optical information reproducing and/or recording equipment should have the optical pickup apparatus mentioned above. In addition, more preferably, the equipment should have other components such as a spindle motor and a power supply.

Furthermore, when the optical pickup apparatus is intended to reproduce information from and/or record information on at least two types of optical information recording media, the optical pickup apparatus embodiment described below can also be applied as one preferred embodiment.

The optical pickup apparatus for reproducing information from, or recording information on, an optical information recording medium comprises: a first light source that emits a first light flux having a first wavelength; a second light source that emits a second light flux having a second wavelength, the second wavelength being different from the first wavelength; and a converging optical system having an optical axis, a diffractive surface, and a photo-detector.

Also, in the case that the first light flux passes through the diffractive surface to emit at least one diffracted ray by which the amount of nth-order diffracted light of the first light flux exceeds the amount of any other order diffracted light of the first light flux, the second light flux passes through the diffractive surface to emit at least one diffracted ray by which the amount of nth-order diffracted light of the second light flux exceeds the amount of any other order diffracted light of the second light flux, wherein “n” stands for a signed integer other than zero, i.e., “n” in the nth order also includes a sign such as +1 or −2.

The optical pickup apparatus is such that recording on and/or reproduction from different types of optical information recording media using at least two wavelengths different from each other can be achieved with one unit. In other words, the optical pickup apparatus can be used for recording on/reproduction from different information recording media, namely, a first optical information recording medium and a second optical information recording medium. For the optical pickup apparatus under the present invention, the first light source emits the first light flux for reproducing information from, or recording information on, a first optical information recording medium, and the second light source emits the second light flux for reproducing information from, or recording information on, a second optical information recording medium; wherein both optical information recording media usually have a transparent substrate on the respective information recording planes.

In other phrases, the function of the present invention can be described as follows:

The converging optical system is capable of converging the nth-order diffracted ray of the first light flux, which is emitted at the diffractive surface by the first light flux reaching it, on the first information recording plane of the first optical information recording medium through the first transparent substrate so as to either reproduce information that has been recorded on the first optical information recording medium or record information on the first optical information recording medium, and the converging optical system is also capable of converging the nth-order diffracted ray of the second light flux, which is emitted at the diffractive surface by the second light flux reaching it, on the second information recording plane of the second optical information recording medium through the second transparent substrate so as to either reproduce information that has been recorded on the second optical information recording medium or record information on the second optical information recording medium; wherein the photo-detector is capable of receiving the light flux reflected from the first information recording plane or the second information recording plane.

A more preferred embodiment is shown next. The converging optical system is capable of converging the nth-order diffracted ray of the first light flux which has passed through the diffractive portion, on the first information recording plane of the first optical information recording medium under the status that the maximum diffraction performance limit or below can be obtained at 0.07 λrms or less in the first light flux at the objective lens image side within the required number of apertures (in order words, when the light flux within actual operating apertures is obtained at the best focus); wherein the converging optical system is also capable of converging the nth-order diffracted ray of the second light flux which has passed through the diffractive portion, on the second information recording plane of the second optical information recording medium under the status that the maximum diffraction performance limit or below can be obtained at 0.07 λrms or less in the first light flux at the objective lens image side within the required number of apertures (in order words, when the light flux within actual operating apertures is obtained at the best focus).

It is preferable that the nth-order diffracted ray be either a plus-signed or minus-signed first-order diffracted ray.

Also, it is preferable that when the diffraction efficiency of the nth-order diffracted ray of the first light flux at the diffractive portion is taken as A % and the diffraction efficiency of the diffracted ray of any other order (preferably, a non-nth order at which the greatest diffraction efficiency can be obtained) is taken as B %, A−B should be equal to or greater than 10, and that when the diffraction efficiency of the nth-order diffracted ray of the second light flux at the diffractive portion is taken as A′ % and the diffraction efficiency of the diffracted ray of any other order is taken as B′ %, A′−B′ should be equal to or greater than 10. In addition, both A′−B′ and A′−B′ should be, preferably, equal to or greater than 30, more preferably, equal to or greater than 50, even more preferably, equal to or greater than 70.

When the refractive surface of the objective lens is to be used as its diffractive surface, it is preferable that the outside diameter of the objective lens (if a flange is provided, the outside diameter of the flange is also included) should be 0.4 to 2.0 mm greater than the diaphragm diameter of the lens.

When only one portion of the surface through which the light flux of the optical element is to be used as its diffractive surface and all other portions are to be used as refractive surfaces, it is preferable that if NA1>NA2, the relationship of NA1>NAH1, NAH1≧NA2, NA2≧NAL1≧0 should hold, wherein NA1 and NA2 denote the number of apertures required at the image side of the objective lens when the first optical information recording medium and the second optical information recording medium, respectively, are to be used. Similarly, NAH1 and NAH2 denote the number of apertures existing in the first light flux and second light flux that have passed through the outermost portion of the diffractive surface, at the image side of the objective lens, and NAL1 and NAL2 denote the number of apertures existing in the first light flux and second light flux that have passed through the innermost portion of the diffractive surface, at the image side of the objective lens.

When only one portion of the surface through which the light flux of the optical element is to be used as its diffractive surface, it is preferable that if NA1>NA2, the light fluxes that have passed through the diffractive surface, and the light that have passed through refractive surfaces, not the diffractive surface, should be almost equal in terms of converging position.

Also, a second diffractive surface can be provided at an outer position more distanced from the optical axis than from the above diffractive surface.

The number of apertures required refers to the number of apertures that enables information to be read from/recorded on an optical information recording medium according to the particular light flux of the required wavelength. Instead, this number of apertures can also be the number specified for the optical information recording medium.

The optical pickup apparatus can also be such that for either one of the light fluxes from the two light sources, only the actual operating apertures required undergo no aberration correction and portions external to these apertures undergo aberration flaring.

In other phrases, the above can be described as follows: the second light flux within the apertures required at the image side of the objective lens when the second light flux is to be used, is converged at 0.07 λrms or less on the second information recording plane of a second optical information recording medium; wherein, when the second light flux is to be used, the wavelength of the second light flux that has passed through the outside of the required apertures at the image side of the objective lens exceeds 0.07 λrms (preferably, 0.1 λrms) on the second information recording plane, and when the second light flux is to be used, the wavelength of the first light flux that has passed through the outside of the required apertures at the image side of the objective lens is also converged at 0.07 λrms or less on the first information recording plane of a first optical information recording medium, in which case, when NA1>NA2 and information is recorded on/reproduced from the second optical information recording medium, the light flux between NA1 and NA2 is flared.

Also, when changes in spherical aberration are plotted on a graph, this graph can be such that it shows continuous spherical aberration or such that it includes a discontinuous portion and spherical aberration abruptly changes at the discontinuous portion.

Different information recording media, namely, a first optical information recording medium and a second optical information recording medium, mean information recording media between which the wavelength of the light to be used for recording/reproduction differs. The thickness of the transparent substrate and the refractive index can be the same or differ between both media. The required number of apertures can also be the same or differ. The thickness of the transparent substrate, however, should preferably differ between the first optical information recording medium and the second optical information recording medium, because greater spherical aberration occurs and thus because the present invention produces more significant effects.

It is also preferable that the difference between the wavelength of the first light flux and that of the second light flux should be 80 nm or more, but up to 400 nm. Any two types of light sources which emit light in wavelength ranges from, for example, 760 to 820 nm, 630 to 670 nm, 350 to 480 nm, etc. can be used as a first light source and a second light source under a preferable combination thereof. When the wavelength of the first light source is taken as λ1, the wavelength of the second light source is taken as λ2, the thickness of the first transparent substrate is taken as t1, the thickness of the second transparent substrate is taken as t2, the number of apertures to be provided at the image side of an objective lens to record information on or reproduce information from the first optical information recording medium using light whose wavelength is λ1, is taken as NA1, and the number of apertures to be provided at the image side of an objective lens to record information on or reproduce information from the second optical information recording medium using light whose wavelength is λ2, is taken as NA2, one preferable example of conditional expressions are shown below, wherein it is also preferable that the nth-order diffracted ray be the first-order diffracted ray. Of course, the preferred embodiments of the present invention are not limited by the following conditional expressions:

λ1<λ2

t1<t2

NA1>NA2 (preferably, NA1>NA20.5×NA1)

When a discontinuous portion is present, it is preferable that in the vicinity of NA2, spherical aberration should have the discontinuous portion. This means that at NA0.45 or NA0.50, for example, spherical aberration should have the discontinuous portion.

Irrespective of whether a discontinuous portion is present on the spherical aberration graph, it is preferable that the spherical aberration at NA1 should be 20 microns or more and that the spherical aberration at NA2 should be 10 microns or less. More preferably, the spherical aberration at NA1 should be 50 microns or more and that the spherical aberration at NA2 should be 2 microns or less.

When a second diffractive surface is to be provided at an outer position more distanced from the optical axis than from the diffractive surface, the following embodiment is also preferred: the converging optical system converges the nth-order diffracted ray of the first light flux from the diffractive surface (first diffractive surface), and any-order diffracted ray of the first light flux from the second diffractive surface on the information recording plane of the first optical information recording medium, through the first transparent substrate so as to reproduce information from or record information on the first optical information recording medium, and the converging optical system converges the nth-order diffracted ray of the second light flux from the diffractive surface on the information recording plane of the second optical information recording medium through the second transparent substrate so as to reproduce information from or record information on the second optical information recording medium.

In the above embodiment, the first diffractive surface and the second diffractive surface can also be formed either as a continuous single-cut surface or as independent surfaces. Or the diffractive surface and the second diffractive surface does not always need to be formed into a continuous single-cut shape.

If, under the above conditions, one type of DVD is to be used as the first optical information recording medium and one type of CD is to be used as the second optical information recording medium, the following embodiment is preferred, but not limited by the conditions

0.55 mm<t1<0.64 mm

1.1 mm<t2<1.3 mm

630 nm<λ<670 nm

760 nm<λ2<820 nm

0.55<NA1<0.68

0.40<NA2<0.55.

The preferred embodiment of the present invention is described in detail below seeing figures.

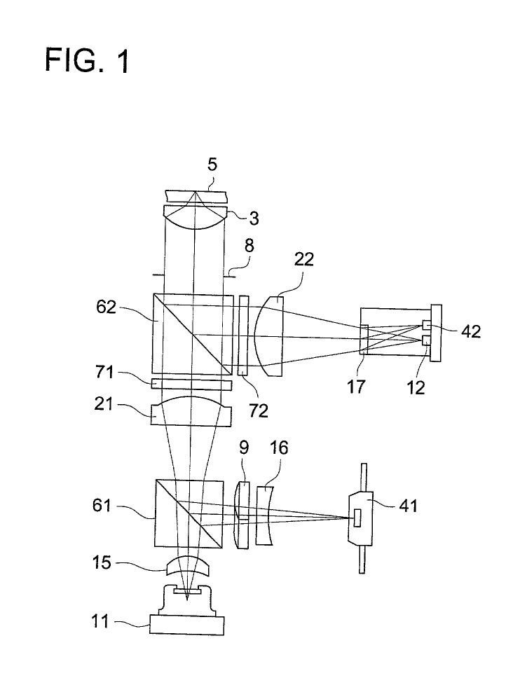

FIG. 1 is a schematic block diagram of the optical pickup apparatus pertaining to this embodiment. The optical pickup apparatus in FIG. 1 has: a first light source 11 used for recording on and/or reproduction from a first optical information recording medium (optical disk); a second light source 12 used for recording on and/or reproduction from a second optical information recording medium (optical disk), the second light source 12 having a wavelength different from that of the first light source 11; coupling lenses 21 and 22 by which the angles of emission of light fluxes from the light sources are converted into the desired angles of emission; a beam splitter 62, which is a photo-synthesizing means for synthesizing the above light fluxes so that these fluxes travel in almost one direction; an objective lens 3 by which the light fluxes from beam splitter 62 are converged on information recording plane 5 of an optical information recording medium; and photo-detectors 41 and 42 for receiving the light reflected from optical information recording media. In the figure, symbol 8 denotes a diaphragm, symbol 9 denotes a cylindrical lens, symbols 71 and 72 denote quarter-wavelength plates, symbol 15 denotes a coupling lens that reduces the light emittance of the light flux emitted from light source 11, symbol 16 denotes a concave lens, symbol 17 denotes a hologram that separates reflected light fluxes. The objective lens shown in embodiment 1 or 2 described later in this SPECIFICATION is used as objective lens 3. The first light source 11 emits laser light whose wavelength $1 is about 405 nm, and the second light source 12 emits laser light whose wavelength $2 is about 650 nm.

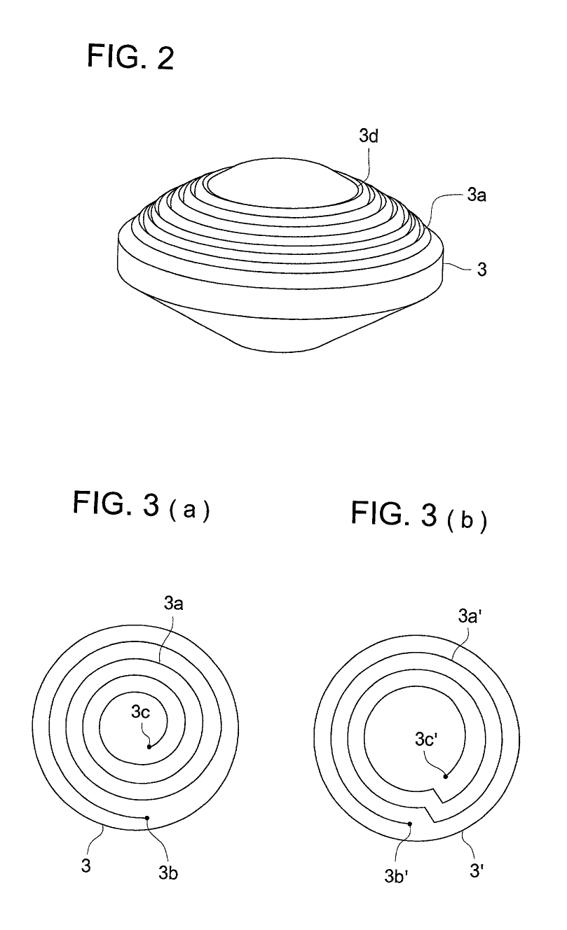

FIG. 2 is a diagonal view of objective lens 3. objective lens 3, which is made of resin, develops a diffraction effect via stepped portion 3a provided with face 3d formed on the optical surface of the lens and extended almost parallel with respect to the optical axis, and thus corrects chromatic aberration and spherical aberration. In FIG. 2, for ease of understanding, stepped portion 3a is drawn in a size larger than its actual value, and for the same purpose, the number of turns drawn in the figure is smaller than its actual value.

FIG. 3 is a view of the objective lens when seen from the direction of its optical axis. In FIG. 3(a), objective lens 3 pertaining to this embodiment is provided with stepped portion 3a formed so as to take a single-cut spiral form when viewed from the direction of the optical axis. In FIG. 3(b), objective lens 3′ pertaining to a modified version of this embodiment is provided with stepped portion 3a′ formed in single-cut form so that coaxially formed and adjacent stepped portions 3a and 3a′ are partly connected, and the rotational angles from respective starting points 3b and 3b′ to ending points 3c and 3c′ are in excess of 360 degrees. That is to say, the faces of stepped portions 3a and 3a′ are continuous in excess of 360 degrees around the optical axis.

Objective lenses 3 and 3′ described above can be manufactured by first forming, on the spherical surface and non-spherical surface of a die, complementing portions for objective lenses 3 and 3′ (these complementing portions include the dents corresponding to stepped portions 3a and 3a′) by the application of a cutting process which uses an ultra-precision CNC lathe and a diamond cutting tool, then injecting a resin material into the die, and curing the resin material. Further details of injection molding are not described below since it is well-known technology.

According to the present invention, it is possible to obtain optical elements that can be increased in diameter so as to create complex surface shapes such as diffraction patterns, that enables the number of ring zones on a diffraction pattern to be increased, and that enables die machining accuracy to be improved with minimum tool damage.

Also, optical elements each having diffraction patterns and/or other complex surface shapes on the curved surface required to be highly accurate for use in an optical pickup apparatus intended for recording on or reproduction from a high-density optical information recording medium which uses a blue semiconductor laser, can also be obtained at lower costs and more accurately. Also, although up to now, because of the difficulty with manufacture, it has only been possible to form a small number of stepped portions and thus the diffraction effects obtained have been correspondingly low, the application of the present invention enables the provision of optical elements from which high diffraction effects can be easily obtained.

Disclosed embodiment can be varied by a skilled person without departing from the spirit and scope of the invention.

What is claimed is:

1. An optical element, comprising:
an optical surface provided with a stepped level difference, wherein when the stepped level difference is viewed from a direction of an optical axis, the stepped level difference is provided in a form of a single continuous line in which a starting point of the line does not agree with an ending point of the line.

2. The optical element of claim 1, wherein when the stepped level difference is viewed from a direction of an optical axis, the stepped level difference is continued from the starting point to the ending point over 360 degrees.

3. The optical element of claim 1, wherein when the stepped level difference is viewed from a direction of an optical axis, the stepped level difference is shaped in a spiral.

4. The optical element of claim 1, wherein when the stepped level difference is viewed from a direction of an optical axis, the single continuous line is made such that in a plurality of coaxial ring-shaped bands, adjacent ring-shaped bands are linked at a part thereof.

5. The optical element of claim 1, wherein the optical element is made of a resin.

6. The optical element of claim 1, wherein the optical element is a optical element for use in an optical pickup apparatus.

7. The optical element of claim 1, wherein the optical element is a lens.

8. The optical element of claim 7, wherein the optical element is an objective lens for use in an optical pickup apparatus.

9. The optical element of claim 7, wherein the optical element is a coupling lens for use in an optical pickup apparatus.

10. The optical element of claim 1, wherein the optical surface is a diffracting surface having a diffracting function.

11. The optical element of claim 10, wherein the diffracting surface is a diffracting surface having an achromatic function.

12. The optical element of claim 10, wherein the optical element is an optical element for use in an optical pickup apparatus conducting recording and/or reproducing information of an optical information recording medium, and wherein in case that a first light flux having a first light wavelength for reproducing or recording information from or onto a first optical information recording medium passes through the diffractive surface to generate at least one diffracted ray, the intensity of an n-th order diffracted ray of the first light flux is greater than that of any other order diffracted ray of the first light flux, and in case that a second light flux having a second light wavelength for reproducing or recording information from or onto a second optical information recording medium passes through the diffractive surface to generate at least one diffracted ray, the intensity of an n-th order diffracted ray of the second light flux is greater than that of any other order diffracted ray of the second light flux, where n stands for an integer other than zero, the first wavelength is different from the second wavelength.

13. An optical pickup apparatus for conducting recording or reproducing information of an optical information recording medium, comprising:
a light source to emit light flux used for recording or reproducing information of the optical information recording medium;
an optical converging system to converge the light flux emitted from the light source onto an information recording plane of the optical information recording medium, and the optical converging system having an optical element; and
a photo-detector to receive the light flux reflected from the information recording plane of the optical information recording medium and to detect the light flux;
wherein the optical element, comprising:
an optical surface provided with a stepped level difference, wherein when the stepped level difference is viewed from a direction of an optical axis, the stepped level difference is provided in a form of a single continuous line in which a starting point of the line does not agree with an ending point of the line.

14. An optical information recording and/or reproducing apparatus for conducting recording or reproducing information of an optical information recording medium, comprising:
an optical pickup apparatus, comprising:
a light source to emit light flux used for recording or reproducing information of the optical information recording medium;
an optical converging system to converge the light flux emitted from the light source onto an information recording plane of the optical information recording medium, and the optical converging system having an optical element; and
a photo-detector to receive the light flux reflected from the information recording plane of the optical information recording medium and to detect the light flux;
wherein the optical element, comprising:
an optical surface provided with a stepped level difference, wherein when the stepped level difference is viewed from a direction of an optical axis, the stepped level difference is provided in a form of a single continuous line in which a starting point of the line does not agree with an ending point of the line.
